(19) United States
(12) Patent Application Publication
(10) Pub. No.: US 2013/0139422 A1
(43) Pub. Date: Jun. 6, 2013

(54) ELECTRIC FIREPLACE COMPRISING A MOVABLE LIGHT SOURCE

(71) Applicants: WEI LIN LU, TAICHUNG (TW); BARRY V. GREENE, BENTONVILLE, AR (US)

(72) Inventors: WEI LIN LU, TAICHUNG (TW); BARRY V. GREENE, BENTONVILLE, AR (US)

(73) Assignee: DONGGUAN SONG WEI ELECTRIC TECHNOLOGY CO., LTD., DONGGUAN (CN)

(21) Appl. No.: 13/308,570

(22) Filed: Dec. 1, 2011

(51) Int. Cl. G09F 19/12

(52) U.S. Cl. 40/428

(57) ABSTRACT

Disclosed herein are electric fireplaces comprising (a) a movable light source comprising a shaft, a plurality of light emitting elements and a plurality of connectors, each of the plurality of connectors connecting one or more of the plurality of light emitting elements to the shaft, wherein the movable light source does not comprise a shell enclosing the plurality of light emitting elements; (b) a simulated fuel bed; and (c) a flame display screen, wherein the flame display screen is located between the movable light source and simulated fuel bed, and wherein the movable light source transmits light on the flame display screen to produce a moving flame effect.

### FIELD OF THE INVENTION

This invention generally relates to electric fireplaces comprising a movable light source, and more particularly electric fireplaces comprising a movable light source having a shaft, a plurality of light emitting elements and a plurality of connectors, each of which connecting one or more of the plurality of light emitting elements to the shaft.

### BACKGROUND OF THE INVENTION

Various types of fireplaces are installed at homes to provide a source of heat and for aesthetic reasons. Fireplaces that are generally available to consumers include traditional wood-burning fireplaces, gas-burning fireplaces and electric fireplaces. Wood-burning fireplaces generally offer the greatest heat-production and aesthetics. However, wood-burning fireplaces not only generally require more work and time to operate, but also present a safety hazard due to the risk of fire spreading into the home. Furthermore, wood-burning fireplaces can be inconvenient and messy because logs must be provided and ashes have to be cleaned. Gas-burning fireplaces offer an actual flame and convenience, but lack the natural sound, flickering, and shadowing associated with wood fires. Gas-burning fireplaces also present safety hazards due to the risks of explosion associated with natural gas combustion.

The current electric fireplaces available in the market offer many safety and convenience features that the wood-burning fireplaces and gas-burning fireplaces do not have. However, although the electric fireplaces can provide simulated flames having visual qualities similar to those of the wood-burning fireplaces or gas-burning fireplaces, they do not offer an actual flame. Generally, the simulated flames lack brightness and transparency of actual flames, and there is no leaping and rising phenomenon of real flickering flames.

Therefore, there is a need for fireplaces that are safe with no risks of fire or explosion. There is also a need for electric fireplaces having simulated flames that more realistically resembles real flames from burning fuels. Furthermore, there is always a need in the market for electric fireplaces with a better design than the current electric fireplaces.

### SUMMARY OF THE INVENTION

Provided herein are electric fireplaces comprising a movable light source. The electric fireplaces provided herein are believed to satisfy the need for electric fireplaces having more realistic simulated flames.

In one aspect, provided herein is an electric fireplace comprising:
(a) a movable light source comprising a shaft, a plurality of light emitting elements and a plurality of connectors, each of the plurality of connectors connecting one or more of the plurality of light emitting elements to the shaft, wherein the movable light source does not comprise a shell enclosing the plurality of light emitting elements;
(b) a simulated fuel bed; and
(c) a flame display screen,
   wherein the flame display screen is located between the movable light source and simulated fuel bed, and wherein the movable light source transmits light on the flame display screen to produce a moving flame effect.

In another aspect, provided herein is an electric fireplace comprising:
(a) a movable light source comprising a shaft, a plurality of light emitting elements and a plurality of connectors, each of the plurality of connectors connecting one or more of the plurality of light emitting elements to the shaft, wherein the movable light source does not comprise a shell enclosing the plurality of light emitting elements;
(b) a simulated fuel bed;
(c) a flame cutout panel; and
(d) a flame display screen,
   wherein the simulated fuel bed is located in front of the flame display screen and the flame cutout panel is located between the flame display screen and the movable light source, and wherein the movable light source transmits light through the flame cutout panel on the flame display screen to produce a moving flame effect.

In certain embodiments, the connectors are printed circuit board (PCB). In certain embodiments, at least a portion of the plurality of connectors extends outward from the shaft. In certain embodiments, at least a portion of the plurality of connectors is on or beneath the surface of the shaft.

In some embodiments, the plurality of light emitting elements in the electric fireplace disclosed herein are incandescent light bulbs, gas discharge lamps, light emitting diodes or a combination thereof.

In certain embodiments, the electric fireplace disclosed herein further comprises a housing having a front wall having a transparent portion, a top wall, a bottom wall, a rear wall, two side walls or a combination thereof.

In some embodiments, the electric fireplace disclosed herein further comprises a rotating means for rotating the movable light source.

In certain embodiments, the electric fireplace disclosed herein further comprises an air blower, a hot air generator or a combination thereof.

In some embodiments, the electric fireplace disclosed herein further comprises a power source and at least one controller. In other embodiments, the at least one controller controls the speed and direction of the movable light source, or the intensity of one or more of the plurality of light emitting elements, or a combination thereof in a manner that produces a moving flame effect.

In certain embodiments, the flame display screen in the electric fireplace disclosed herein has two non-reflecting surfaces, two reflecting surfaces, or one non-reflecting surface and one reflecting surface.

In some embodiments, the electric fireplace disclosed herein further comprises a fixed light source below the simulated fuel bed.

### BRIEF DESCRIPTION OF THE DRAWINGS

FIG. 1 depicts a front view of a first embodiment of the movable light source disclosed herein.

FIG. 2 depicts a perspective view of a first embodiment of an electric fireplace assembly disclosed herein having the movable light source of FIG. 1 behind a flame display screen.

FIG. 3A depicts a perspective view of a second embodiment of an electric fireplace assembly disclosed herein having the movable light source of FIG. 1, a flame display screen, and a flame cutout panel between the movable light source and the flame display screen.

FIG. 3B depicts a side view of the electric fireplace assembly of FIG. 3A in a housing comprising a front wall, a rear wall, a top wall, a bottom wall and two side walls (not shown).

FIG. 4 depicts a perspective view of the electric fireplace assembly of FIG. 2 or FIG. 3A in a housing comprising a rear wall, a bottom wall and two side walls.

FIG. 5 depicts a front view of a second embodiment of the movable light source disclosed herein.

FIG. 6 depicts a perspective view of a third embodiment of an electric fireplace assembly disclosed herein having the movable light source of FIG. 5 behind a flame display screen.

FIG. 7A depicts a perspective view of a fourth embodiment of an electric fireplace assembly disclosed herein having the movable light source of FIG. 5, a flame display screen, and a flame cutout panel between the movable light source and the flame display screen.

FIG. 7B depicts a side view of the electric fireplace assembly of FIG. 6 or FIG. 7A in a housing comprising a front wall, a rear wall, a top wall, a bottom wall and two side walls (not shown).

FIG. 8 depicts a front view of a third embodiment of the movable light source disclosed herein.

FIG. 9 depicts a perspective view of a fifth embodiment of an electric fireplace assembly having the movable light source of FIG. 8 behind a flame display screen.

FIG. 10A depicts a perspective view of a sixth embodiment of an electric fireplace assembly having the movable light source of FIG. 8, a flame display screen, and a flame cutout panel between the movable light source and the flame display screen.

FIG. 10B depicts a side view of the electric fireplace assembly of FIG. 9 or FIG. 10A in a housing comprising a front wall, a rear wall, a top wall, a bottom wall and two side walls (not shown).

### DETAILED DESCRIPTION OF THE INVENTION

In one aspect, provided herein is an electric fireplace comprising:
(a) a movable light source comprising a shaft, a plurality of light emitting elements and a plurality of connectors, each of the plurality of connectors connecting one or more of the plurality of light emitting elements to the shaft, wherein the movable light source does not comprise a shell enclosing the plurality of light emitting elements;
(b) a simulated fuel bed; and
(c) a flame display screen,
   wherein the flame display screen is located between the movable light source and simulated fuel bed, and wherein the movable light source transmits light on the flame display screen to produce a moving flame effect.

In another aspect, provided herein is an electric fireplace comprising:
(a) a movable light source comprising a shaft, a plurality of light emitting elements and a plurality of connectors, each of the plurality of connectors connecting one or more of the plurality of light emitting elements to the shaft, wherein the movable light source does not comprise a shell enclosing the plurality of light emitting elements;
(b) a simulated fuel bed;
(c) a flame cutout panel; and
(c) a flame display screen,
   wherein the simulated fuel bed is located in front of the flame display screen and the flame cutout panel is located between the flame display screen and the movable light source, and wherein the movable light source transmits light through the flame cutout panel on the flame display screen to produce a moving flame effect.

The shaft of movable light source can be in any shape and size that are suitable for placing the light emitting elements in a manner that can produce a moving flame effect. In some embodiments, the shaft is in the shape of a cylinder, triangular prism, square prism, pentagonal prism, hexagonal prism, heptagonal octagonal, nonagonal prism, decagonal prism, or the like. In some embodiments, the shaft is a uniform cylinder having a cross-sectional diameter from 1 mm to 100 cm, from 1 mm to 50 cm, from 1 mm to 20 cm, from 1 mm to 10 cm, from 1 mm to 5 cm, from 1 mm to 4 cm, from 1 mm to 3 cm, from 1 mm to 2 cm, or from 1 mm to 1 cm. In some embodiments, the cross-sectional diameter of the shaft is not uniform. The shaft can be driven by any known mechanical, electrical or electromechanical devise such as a motor that can be used to move or rotate the shaft. The mechanical or electrical devise can be in turn controlled by any known controller that can control the speed and movement direction of the shaft.

The plurality of connectors generally are made from non-reflective material. In some embodiments, at least a portion of the plurality of connectors extends outward and/or radially from the surface of the shaft. In certain embodiments, at least a portion of the plurality of connectors is on or beneath the surface of the shaft. In some embodiments, the plurality of connectors are made of plastic, paper, metal, glass, crystal, cloth, quartz or any other non-reflective materials, or a combination thereof. In certain embodiments, the plurality of connectors is arranged in the form of a rack, a wheel or any other suitable form.

The light emitting elements can be any source that emit light. In some embodiments, the light emitting element can emit light with different colors. In certain embodiments, the light emitting element can emit light with different shapes. In other embodiments, the light emitting element can be a natural gas flame.

In some embodiments, the plurality of light emitting elements in the electric fireplace disclosed herein are incandescent light bulbs, gas discharge lamps, light emitting diodes or a combination thereof. Some none-limiting examples of suitable incandescent light bulbs include conventional incandescent light bulbs, halogen lamps, and carbon button lamps. Some none-limiting examples of suitable gas discharge lamps include fluorescent lamps, compact fluorescent lamps, inductive lighting, hollow cathode lamps, neon and argon lamps. plasma lamps, and xenon flash lamps. Some none-limiting examples of suitable light emitting diodes include semiconductor-type light-emitting diodes, organic light-emitting diodes, polymer light-emitting diodes, solid-state lighting and LED lamps.

In some embodiments, the movable light source does not comprise a wall or shell having one or more openings for transmitting lights. In certain embodiments, the movable light source does not comprise a wall or shell having one or more a flame-shaped or fire-shaped openings for transmitting lights. In some embodiments, the movable light source does not comprise a wall or shell having one or more openings which are adapted to configures the light from the movable light source into an image of moving flames. In certain embodiments, the movable light source does not comprise one or more reflective articles or elements.

In some embodiments, the electric fireplace disclosed herein further comprises a means for rotating the movable light source. In some embodiments, the rotating means comprises a mechanical device, an electrical device, an electromechanical device or a micro-electromechanical device. In certain embodiment, the rotating means is an electric motor or a hydraulic motor. Some non-limiting examples of electric motors include magnetic motors (such as DC motors, AC motors, and stepper motors), electrostatic motors, and piezoelectric motors. In some embodiments, the rotating means further comprises gears, capable of transmitting torque and rotation through shafts. In some embodiments, the rotating means is powered by a power source and/or controlled by any known controller that can control the speed and movement direction of the movable light source.

In certain embodiments, the electric fireplace disclosed herein further comprises a housing. The housing can comprise any component or article that enclosing the elements of the electric fireplace. In some embodiments, the housing has a front wall having a transparent portion, a top wall, a bottom wall, a rear wall, two side walls or a combination thereof. In certain embodiments, the walls are planar or curved or a combination thereof. In some embodiments, the housing is made of wood, plastic, paper, metal, glass, crystal, cloth or a combination thereof. In some embodiments, the housing is colored such as red, orange, yellow, green, blue, indigo, purple, brown, white, black, metallic, silver, gold, a natural wood color or a combination thereof. In certain embodiments, the housing comprises one or more handles, one or more vents, one or more fans or a combination thereof.

In certain embodiments, the electric fireplace disclosed herein further comprises an air blower, a hot air generator or a combination thereof.

In certain embodiments, the electric fireplace disclosed herein further comprises a power source and at least one controller. In other embodiments, the at least one controller controls the speed and movement direction of the movable light source, or the intensity of one or more of the plurality of light emitting elements, or a combination thereof in a manner that produces a moving flame effect.

The flame display screen can be any component or article that providing at least one surface for transmitting an image of flames. In certain embodiments, the flame display screen is planar. In some embodiments, the flame display screen includes a curved portion. The flame display screen can be curved in a vertical direction or/and in a horizontal direction to correspond to the profile of the simulated fuel bed. In certain embodiments, the flame display screen is colored. In some embodiments, the flame display screen can be made of plastic, paper, metal, glass, crystal, cloth, quartz or any materials suitable for screen.

In certain embodiments, the flame display screen is located between the movable light source and simulated fuel bed, and wherein the movable light source transmits light on the flame display screen to produce a moving flame effect. In some embodiments, the flame display screen has two non-reflecting surfaces, two reflecting surfaces, or one non-reflecting surface and one reflecting surface. In certain embodiments, the flame display screen has two magnifying surfaces, two minifying surfaces, or one magnifying surface and one minifying surface.

The simulated fuel bed can be any component or article that simulating a burning or glowing combustible materials. In some embodiments, the simulated combustible materials comprise artificial or simulated wood, logs, charcoal, ember, books, paper, coal, leaf, tree trunks, cloths, photos, bottles or a combination thereof. In other embodiments, the simulated fuel bed comprise artificial or simulated logs and bed of embers so as to create the illusion that burning logs on top of a bed of glowing embers. In some embodiments, the simulated fuel bed comprises a shell and colored to resemble logs and embers for a log burning fire, wherein the shell can be made of plastic or any other materials. In some embodiments, the shell comprises a plurality of light transmitting portions that allows light from a fixed light source under the simulated fuel bed to glow on the top surface of the simulated fuel bed in a pattern similar to a real fuel bed.

The flame cutout panel can be any panel or sheet that can create or enhance the desirable moving flame effect. In certain embodiments, the flame cutout panel can be made of a panel of light-blocking material having one or more portions therein cut out in the pattern of flames. In some embodiments, the flame cutout panel is a sheet having non-translucent part and having translucent part with at last a flame pattern which configures the light from the movable light source into an image of moving flames. In other embodiments, the flame cutout panel disclosed herein can be made of paper, glass, plastic, metal, cloth, crystal, stainless steel, quartz or a combination thereof. In certain embodiment, the flame cutout panel is formed from a substantially opaque material. In some embodiment, the flame cutout panel is formed from substantially reflective material.

In some embodiments, the flame cutout panel is located between the flame display screen and the movable light source, and wherein the movable light source transmits light through the flame cutout panel on the flame display screen to produce a moving flame effect. In certain embodiments, the flame pattern is cut into a sheet to provide an opening which configures the light from the movable light source into an image of flames.

In some embodiments, the fireplace further comprise a simulated grate. In certain embodiment, the simulated grate comprises a plurality of prongs, disposed substantially parallel to each other, extending generally upwardly, and disposed substantially along a central part of the simulated fuel bed.

In certain embodiments, the electric fireplace disclosed herein further comprises a fixed light source below the simulated fuel bed. In certain embodiments, the fixed light source comprises a plurality of light emitting elements as disclosed herein. In some embodiments, the fixed light source emits light with different colors. In certain embodiments, the fixed light source emits light with different shapes. In some embodiments, the fixed light source is a natural gas flame.

In certain embodiments, the electric fireplace disclosed herein further comprises any conventional power source or alternative power source. In some embodiments, the power source can be a household electrical source or battery. In certain embodiments, the alternative power source comprise heat, renewable energy, electrical power produced through the use of the gravitational force of falling or flowing water or a combination thereof. In some embodiments, the renewable energy comprises solar, wind energy or a combination thereof. In certain embodiments, the rotating means can be powered by mechanical energy manually supplied to a spring. In some embodiment, the mechanical device can be driven with spring-operated lifting means or weight operated lifting means.

In certain embodiments, the electric fireplace disclosed herein further comprises an air blower. Any air blower that propels air forward can be used herein. Some non-limiting examples of the air blower include forward-curved air blowers, backward-inclined air blowers, backward-curved air blowers, radial air blowers and airfoil air blowers. In certain embodiments, the air blower comprises a humidifier.

In certain embodiments, the electric fireplace disclosed herein further comprises a hot air generator. Any hot air generator that produce hot air can be used herein. In certain embodiments, the hot air generator comprises the humidifier.

In certain embodiments, the electric fireplace disclosed herein further comprises a controller. In some embodiments, the controller comprises one or more modules, including a memory storage means and a user interface. In some embodiments, the controller can include, for example, firmware which provides options selectable by a user via the user interface. In addition, or in the alternative, direct (manual) control by the user via the user interface may be permitted. Alternatively, the controller could be programmed to cause variations in the light produced by the LEDs in accordance with a predetermined sequence in a program stored in memory. In some embodiments, the controller includes any suitable means for causing light created by the light source to vary as required, e.g., a triac to vary voltage as required, as is known in the art. In certain embodiments, the controller is controllable by a user. In some embodiments, the signal from the controller is captured by a sensor. In certain embodiments, the controller controls the speed and movement direction of the movable light source, or the intensity of one or more of the plurality of light emitting elements, or a combination thereof in a manner that produces a moving flame effect. In certain embodiments, the controller controls the temperature of the air generated from the air blower or the hot air generator or the intensity level of the humidifier. In some embodiments, the controller can switch on or off the movable light source, the air blower or the hot air generator or the intensity level of the humidifier.

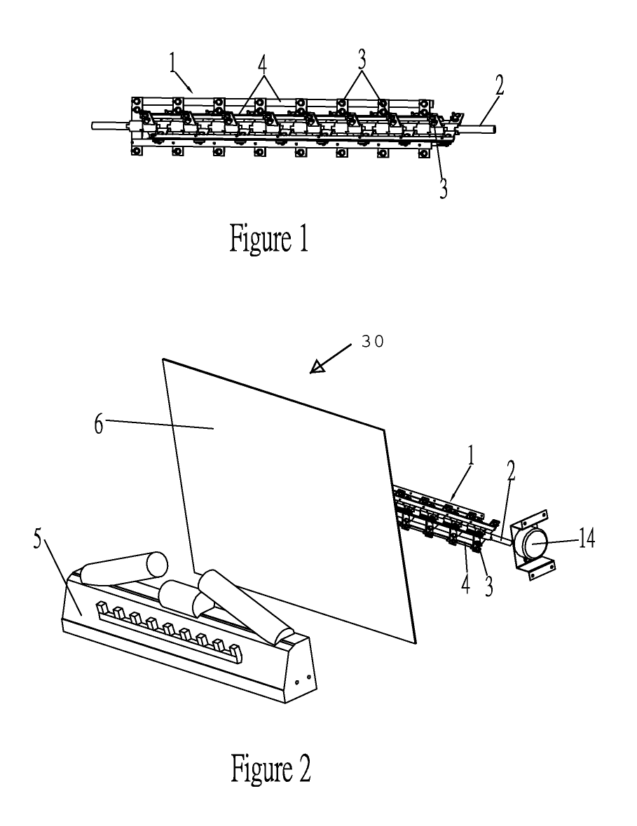

FIG. 1 depicts a front view of a first embodiment of the movable light source 1. The movable light source 1 comprises a shaft 2, a plurality of light emitting elements 3 and a plurality of connectors 4 connecting the plurality of light emitting elements 3 to the shaft 2. The shaft 2 is in the shape of a cylinder. The plurality of connectors 4 are extended radially from the surface of the shaft 2. The plurality of light emitting elements 3 are distributed on the surface of the plurality of connectors 4.

FIG. 2 depicts a perspective view of a first embodiment of an electric fireplace assembly 30, showing the first embodiment of the movable light source 1 behind a flame display screen 6. The movable light source 1 further connected to a rotating means 14 for rotating the movable light source 1. A controller (not shown) may be used to control the speed and direction of the movable light source 1, or the intensity of one or more of the plurality of light emitting elements 3, or a combination thereof in a manner that produces a moving flame effect on the flame display screen 6. The flame display screen 6 is located immediately behind a simulated fuel bed 5.

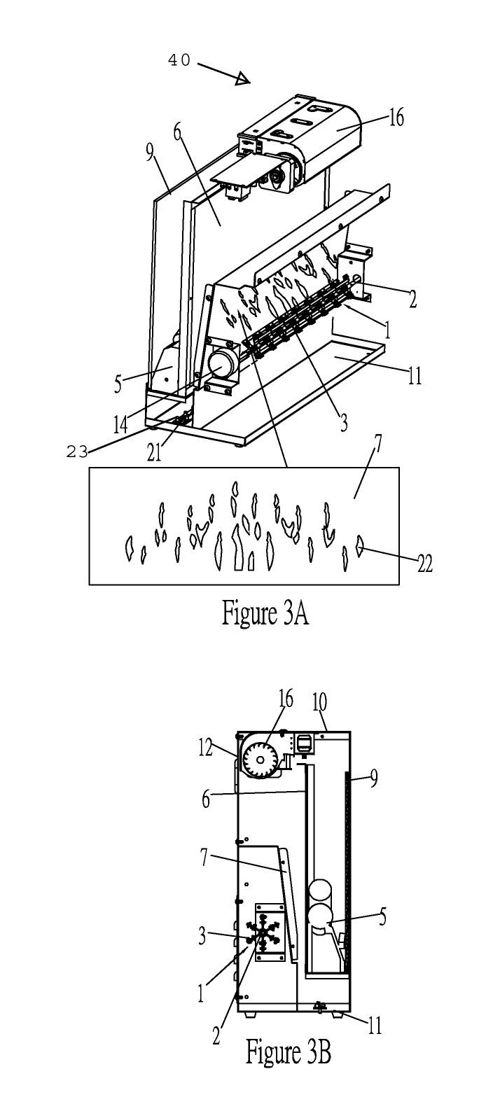

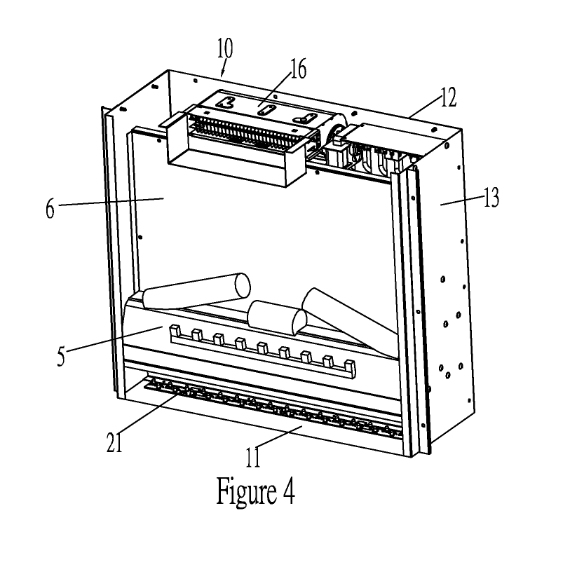

FIG. 3A depicts a perspective view of a second embodiment of an electric fireplace assembly 40, showing the first embodiment of the movable light source 1 behind a flame cutout panel 7. The flame cutout panel 7 comprising a plurality of openings 22 is located immediately behind a flame display screen 6. The first embodiment of the movable light source 1 transmits light through the flame cutout panel 7 on the flame display screen 6 to product a moving flame effect on the flame display screen 6. The moving flame effect may be enhanced by using a controller (not shown) to control the speed and direction of the movable light source 1, or the intensity of one or more of the plurality of light emitting elements 3, or a combination thereof. The flame display screen 6 is located immediately behind a simulated fuel bed 5. A fixed light source 21 is situated below the simulated fuel bed 5 and affixed to the bottom wall 11. The fixed light source 21 comprises a second plurality of light emitting elements 23, which have same or different colors and shine at different intensities at different times in order to give the effect of a flickering fire or a glowing ember. A hot air generator 16 is located at the top of the electric fireplace assembly.

FIG. 3B depicts a side view of the electric fireplace assembly 40 in a housing 8. The housing 8 has a front wall 9 having a transparent portion, a top wall 10, a bottom wall 11, a rear wall 12, and two side walls 13 (not shown).

FIG. 4 depicts a perspective view of the electric fireplace assembly 30 or 40 in a housing having a bottom wall 11, a rear wall 12, and two side walls 13.

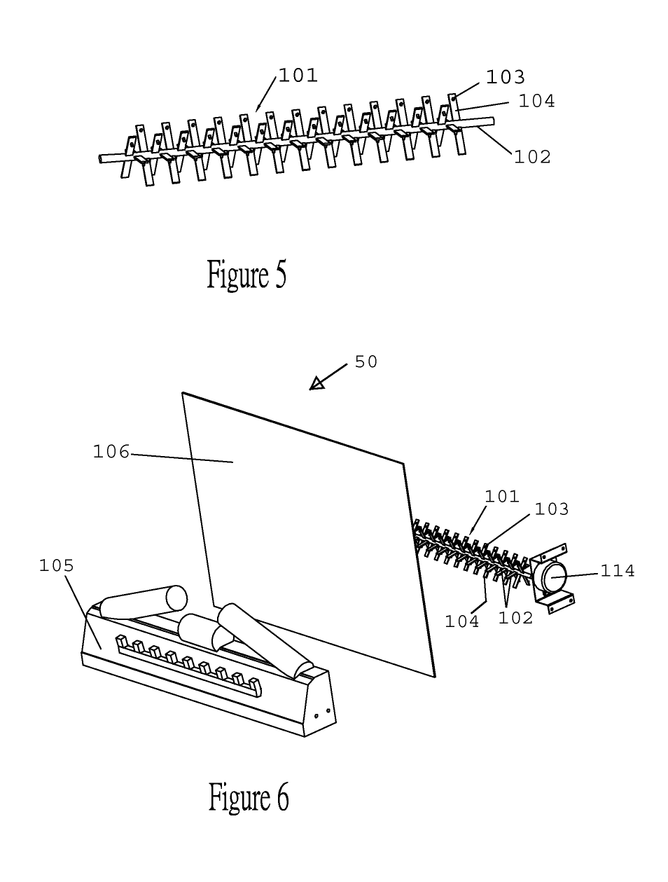

FIG. 5 depicts a front view of a second embodiment of the movable light source 101. The movable light source 101 comprises a shaft 102, a plurality of light emitting elements 103 and a plurality of connectors 104 connecting the plurality of light emitting elements 103 to the shaft 102. The shaft 102 is in the shape of a cylinder. The plurality of connectors 104 are extended radially from the surface of the shaft 102. The plurality of light emitting elements 103 are distributed on the surface of the plurality of connectors 104.

FIG. 6 depicts a perspective view of a third embodiment of an electric fireplace assembly 50, showing the second embodiment of the movable light source 101 behind a flame display screen 106. The second embodiment of the movable light source 101 further connected to a rotating means 114 for rotating the movable light source 101. A controller (not shown) may be used to control the speed and direction of the movable light source 101, or the intensity of one or more of the plurality of light emitting elements 103, or a combination thereof in a manner that produces a moving flame effect on the flame display screen 106. The flame display screen 106 is located immediately behind a simulated fuel bed 105.

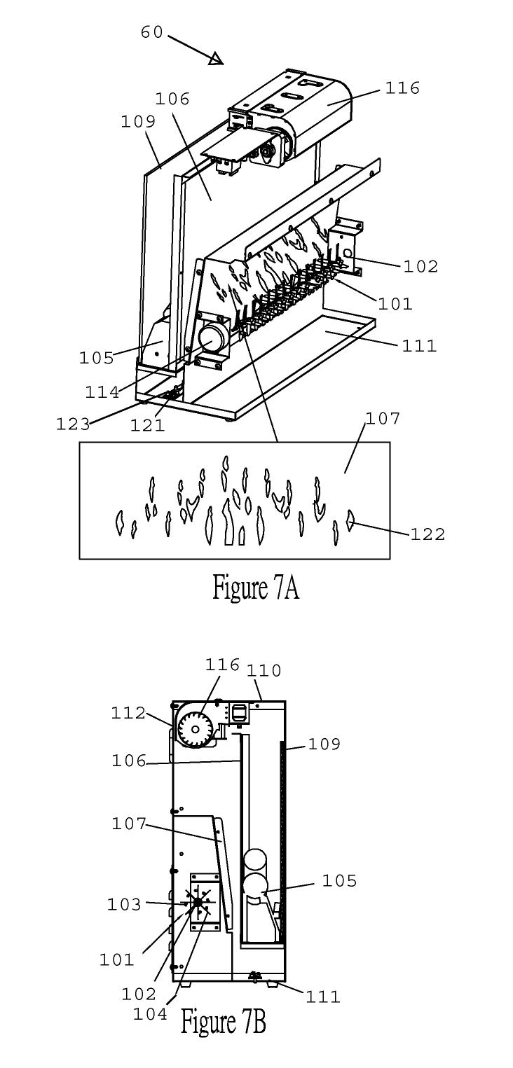

FIG. 7A depicts a perspective view of a forth embodiment of an electric fireplace assembly 40, showing the second embodiment of the movable light source 101 behind a flame cutout panel 107. The flame cutout panel 107 comprising a plurality of openings 122 is located immediately behind a flame display screen 106. The movable light source 101 transmits light through the flame cutout panel 7 on the flame display screen 106 to product a moving flame effect on the flame display screen 106. The moving flame effect may be enhanced by using a controller (not shown) to control the speed and direction of the movable light source 101, or the intensity of one or more of the plurality of light emitting elements 103, or a combination thereof. The flame display screen 106 is located immediately behind a simulated fuel bed 105. A fixed light source 121 is situated below the simulated fuel bed 105 and affixed to the bottom wall 111. The fixed light source 121 comprises a second plurality of light emitting elements 123, which have same or different colors and shine at different intensities at different times in order to give the effect of a flickering fire or a glowing ember. A hot air generator 116 is located at the top of the electric fireplace assembly.

FIG. 7B depicts a side view of the electric fireplace assembly 60 in a housing 108. The housing 108 has a front wall 109 having a transparent portion, a top wall 110, a bottom wall 111, a rear wall 112, and two side walls 113 (not shown).

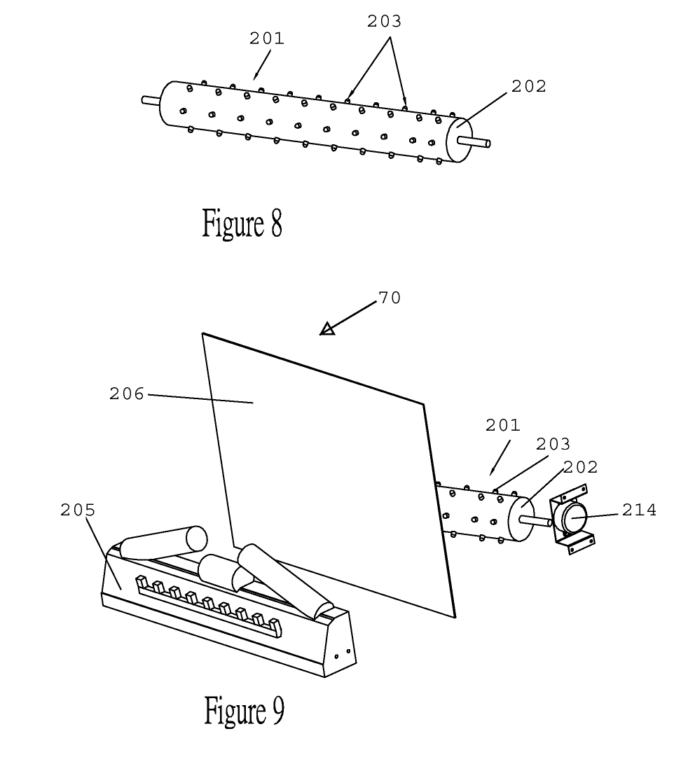

FIG. 8 depicts a front view of a third embodiment of the movable light source 201. The movable light source 201 comprises a shaft 202, a plurality of light emitting elements 203 and a plurality of connectors (not shown) connecting the plurality of light emitting elements 203 to the shaft 202. The shaft 202 is in the shape of a cylinder. The plurality of connectors are beneath the surface of the shaft 202.

FIG. 9 depicts a perspective view of a fifth embodiment of an electric fireplace assembly 70, showing the third embodiment of the movable light source 201 behind a flame display screen 206. The third embodiment of the movable light source 201 further connected to a rotating means 214 for rotating the movable light source 201. A controller (not shown) may be used to control the speed and direction of the movable light source 201, or the intensity of one or more of the plurality of light emitting elements 203, or a combination thereof in a manner that produces a moving flame effect on the flame display screen 206. The flame display screen 206 is located immediately behind a simulated fuel bed 205.

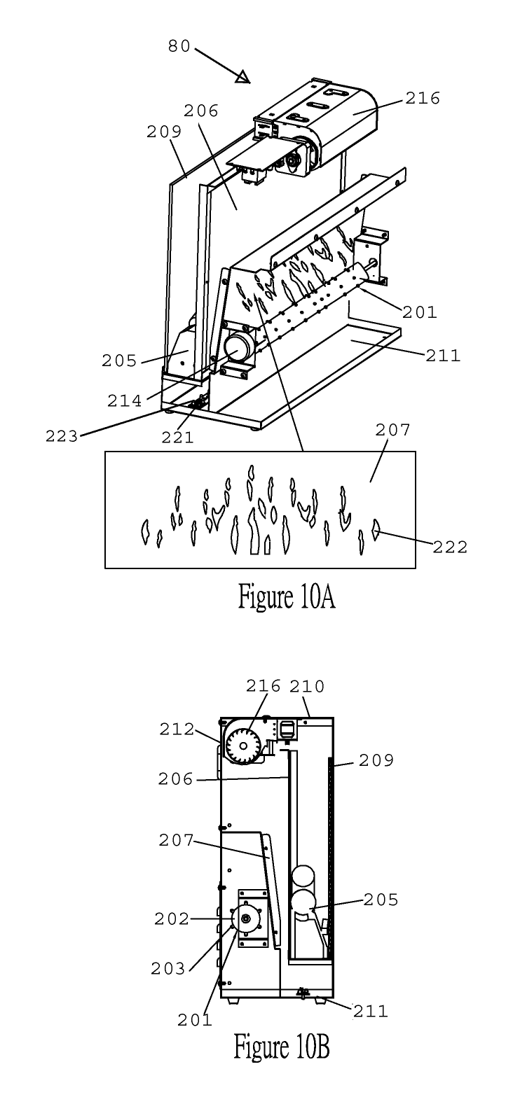

FIG. 10A depicts a perspective view of a sixth embodiment of an electric fireplace assembly 80, showing the third embodiment of the movable light source 201 behind a flame cutout panel 207. The flame cutout panel 207 comprising a plurality of openings 222 is located immediately behind a flame display screen 206. The movable light source 201 transmits light through the flame cutout panel 7 on the flame display screen 106 to product a moving flame effect on the flame display screen 106. The moving flame effect may be enhanced by using a controller (not shown) to control the speed and direction of the movable light source 201, or the intensity of one or more of the plurality of light emitting elements 203, or a combination thereof. The flame display screen 206 is located immediately behind a simulated fuel bed 205. A fixed light source 221 is situated below the simulated fuel bed 205 and affixed to the bottom wall 211. The fixed light source 221 comprises a second plurality of light emitting elements 223, which have same or different colors and shine at different intensities at different times in order to give the effect of a flickering fire or a glowing ember. A hot air generator 216 is located at the top of the electric fireplace assembly.

FIG. 10B depicts a side view of the electric fireplace assembly 80 in a housing 208. The housing 208 has a front wall 209 having a transparent portion, a top wall 210, a bottom wall 211, a rear wall 212, and two side walls 213 (not shown).

While the invention has been described with respect to a limited number of embodiments, the specific features of one embodiment should not be attributed to other embodiments of the invention. No single embodiment is representative of all aspects of the invention. In some embodiments, the compositions may include numerous compounds not mentioned herein. In other embodiments, the compositions do not include, or are substantially free of, any compounds not enumerated herein. Variations and modifications from the described embodiments exist. For example, the fuel disclosed herein needs not be a mixture of alcohol. It can comprise any type of hydrocarbons or fatty esters or other biofuels. The appended claims intend to cover all such variations and modifications as falling within the scope of the invention.

All publications and patent applications mentioned in this specification are herein incorporated by reference to the same extent as if each individual publication or patent application was specifically and individually indicated to be incorporated by reference. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. An electric fireplace comprising:
(a) a movable light source comprising a shaft, a plurality of light emitting elements and a plurality of connectors, each of the plurality of connectors connecting one or more of the plurality of light emitting elements to the shaft, wherein the movable light source does not comprise a shell enclosing the plurality of light emitting elements;
(b) a simulated fuel bed; and
(c) a flame display screen,
wherein the flame display screen is located between the movable light source and simulated fuel bed, and wherein the movable light source transmits light on the flame display screen to produce a moving flame effect.

2. The electric fireplace of claim 1, wherein the plurality of light emitting elements are incandescent light bulbs, gas discharge lamps, light emitting diodes or a combination thereof.

3. The electric fireplace of claim 1, wherein the electric fireplace further comprises a housing having a front wall having a transparent portion, a top wall, a bottom wall, a rear wall, two side walls or a combination thereof.

4. The electric fireplace of claim 1, wherein the electric fireplace further comprises a rotating means for rotating the movable light source.

5. The electric fireplace of claim 1, wherein the electric fireplace further comprises an air blower, a hot air generator or a combination thereof.

6. The electric fireplace of claim 1, wherein the electric fireplace further comprises a power source and at least one controller.

7. The electric fireplace of claim 1, wherein the flame display screen has two non-reflecting surfaces, two reflecting surfaces, or one non-reflecting surface and one reflecting surface.

8. The electric fireplace of claim 1, wherein at least a portion of the plurality of connectors extend outward from the shaft.

9. The electric fireplace of claim 1, wherein at least a portion of the plurality of connectors are on or beneath the surface of the shaft.

10. The electric fireplace of claim 1, wherein the at least one controller controls the speed and direction of the movable light source, or the intensity of one or more of the plurality of light emitting elements, or a combination thereof in a manner that produces a moving flame effect.

11. An electric fireplace comprising:
(a) a movable light source comprising a shaft, a plurality of light emitting elements and a plurality of connectors, each of the plurality of connectors connecting one or more of the plurality of light emitting elements to the shaft, wherein the movable light source does not comprise a shell enclosing the plurality of light emitting elements;
(b) a simulated fuel bed;
(c) a flame cutout panel; and
(d) a flame display screen,
wherein the simulated fuel bed is located in front of the flame display screen and the flame cutout panel is located between the flame display screen and the movable light source, and wherein the movable light source transmits light through the flame cutout panel on the flame display screen to produce a moving flame effect.

12. The electric fireplace of claim 11, wherein the plurality of light emitting elements are incandescent light bulbs, gas discharge lamps, light emitting diodes or a combination thereof.

13. The electric fireplace of claim 11, wherein the electric fireplace further comprises a housing having a front wall having a transparent portion, a top wall, a bottom wall, a rear wall, two side walls or a combination thereof.

14. The electric fireplace of claim 11, wherein the electric fireplace further comprises a rotating means for rotating the movable light source.

15. The electric fireplace of claim 11, wherein the electric fireplace further comprises an air blower, a hot air generator or a combination thereof.

16. The electric fireplace of claim 11, wherein the electric fireplace further comprises a power source and at least one controller.

17. The electric fireplace of claim 11, wherein the flame display screen has two non-reflecting surfaces, two reflecting surfaces, or one non-reflecting surface and one reflecting surface.

18. The electric fireplace of claim 11, wherein at least a portion of the plurality of connectors extend outward from the shaft.

19. The electric fireplace of claim 11, wherein at least a portion of the plurality of connectors are on or beneath the surface of the shaft.

20. The electric fireplace of claim 11, wherein the electric fireplace further comprises a fixed light source below the simulated fuel bed.
